(19) United States
(12) Patent Application Publication
(10) Pub. No.: US 2017/0108805 A1
(43) Pub. Date: Apr. 20, 2017

(54) FIXING DEVICE

(71) Applicant: CANON KABUSHIKI KAISHA, Tokyo (JP)

(72) Inventors: Koji Nojima, Abiko-shi (JP); Kota Aoki, Toride-shi (JP)

(73) Assignee: CANON KABUSHIKI KAISHA, Tokyo (JP)

(21) Appl. No.: 15/316,863

(22) PCT Filed: Sep. 10, 2015
(86) PCT No.: PCT/JP2015/076373

§ 371 Date: Dec. 7, 2016

(30) Foreign Application Priority Data
Sep. 10, 2014 (JP) 2014-183953

(51) Int. Cl. G03G 15/20

(52) U.S. Cl. CPC G03G 15/2025

(57) ABSTRACT

A fixing apparatus includes a first rotatable member configured to heat, in a fixing nip, an unfixed toner image formed on a sheet with toner comprising the parting material; a second rotatable member cooperative with the first rotatable member to form the fixing nip; a cleaner configured to clean the first rotatable member; and a covering member configured to cover the first rotatable member over a range from the cleaner to a neighborhood of an entrance of the fixing nip along a rotational direction of the first rotatable member with a gap of not less than 0.5 mm and not more than 3.5 mm.

### FIELD OF THE INVENTION

The present invention relates to a fixing device which fixes a toner image on a sheet of recording medium. A fixing device can be installed in image forming apparatus such as a copying machine, a printer, and a facsimile machine, and also, in multifunction image forming apparatuses which are capable of performing two or more functions of the preceding image forming apparatuses.

### BACKGROUND ART

In the field of an electrophotographic image forming apparatus, it has been a common practice to use such toner that contains a releasing agent (wax), to form a toner image on a sheet of recording medium, and use a fixing device to fix the formed toner image to the sheet by applying heat and pressure to the sheet and the toner image thereon.

In is known that during the fixation of a toner image, the wax in toner vaporizes, and then, immediately condenses. It has been known by the inventors of the present invention that after the wax vaporizes and condenses, a large amount of microscopic particles of wax (which are several nanometers to several hundreds of nanometer in diameter, and hereafter may be referred to as dust) remain floating in the adjacencies of the fixing member of the fixing device. Unless these microscopic particles of wax, which result from the condensation of vaporized wax from the toner is dealt with immediately after the condensation, it is possible that most of the particles will disperse out of the fixing device, which will have undesirable effects upon the images which are being formed by the image forming apparatus. Thus, in order to prevent the microscopic wax particles from dispersing out of the fixing device, it has been desired to turn the microscopic wax particles into particles of a larger size as soon as they are formed through the condensation of the vaporized wax.

In the case of the fixing device disclosed in Japanese Laid-open Patent Application 2010-217580, which employs an electromagnetic induction heating system, a heating member is disposed in the adjacencies of the coil holder of the device, in order to prevent the wax from cumulatively solidifying on the coil holder. More concretely, the fixing device is configured so that as the cumulatively solidified wax on the coil holder is heated by the heating member, the wax liquefies and drips down.

In the case of the fixing device disclosed in Japanese Laid-open Patent Application 2011-112708, the cleaning web for removing the microscopic particles, which are remaining adhering to the fixation roller, is made of such material that contains an agent which is capable of capturing the microscopic particles.

However, in the case of the fixing devices disclosed in Japanese Laid-open Patent Applications 2010-217580 and 2011-112708, it is impossible to prevent the large amount of dust, which is present in the adjacencies of the fixing member, from dispersing out of the fixing device. In other words, these patents cannot be solutions to the above-described problem.

### SUMMARY OF THE INVENTION

Thus, the object of the present invention is to provide a fixing device which can prevent the dust from dispersing straight out of the fixing device.

Another object of the present invention is to provide a fixing device which is greater in efficiency in terms of the process of turning the dust into particles of larger sizes than any conventional fixing device.

According to an aspect of the present invention, there is provided a fixing apparatus comprising a first rotatable member configured to heat, in a fixing nip, an unfixed toner image formed on a sheet with toner comprising the parting material; a second rotatable member cooperative with said first rotatable member to form the fixing nip; a cleaner configured to clean said first rotatable member; and a covering member configured to cover said first rotatable member over a range from said cleaner to a neighborhood of an entrance of said fixing nip along a rotational direction of said first rotatable member with a gap of not less than 0.5 mm and not more than 3.5 mm.

Further features of the present invention will become apparent from the following description of exemplary embodiments with reference to the attached drawings.

### BRIEF DESCRIPTION OF THE DRAWINGS

Part (a) of FIG. 1 is a schematic cross-sectional view of the essential section of the fixing device in one of the preferred embodiments of the present invention, and part (b) of FIG. 1 is a perspective view of the essential section of the same fixing device.

FIG. 2 is a front view of the essential section of the fixing device.

Parts (a), (b) and (c) of FIG. 3 illustrate the coil assembly.

FIG. 4 is a schematic sectional view of the image forming apparatus in the embodiment, and shows the general structure of the apparatus.

FIG. 5 is a drawing for describing the airflow in the adjacencies of the fixation roller, and that in the adjacencies of the pressure roller.

FIG. 6 is a graph which shows the relationship between the gap and peripheral velocity.

Parts (a), (b) and (c) of FIG. 7 illustrate the range in which the wax adheres to the fixation roller, and the range in which dust forms.

Part (a) of FIG. 8 is a schematic drawing for describing how the dust particles agglomerate into particles of larger size, and part (b) of FIG. 8 is a schematic drawing for describing how and where the dust adheres in the fixing device.

### DESCRIPTION OF THE EMBODIMENTS

Hereinafter, one of the preferred examples of fixing device which are in accordance with the present invention is described in detail. By the way, the various devices, components thereof, etc., in the following embodiment of the present invention can be replaced with any known structure, within the scope of the present invention, unless specifically noted.

### Embodiment

### (1) Example of Image Forming Apparatus

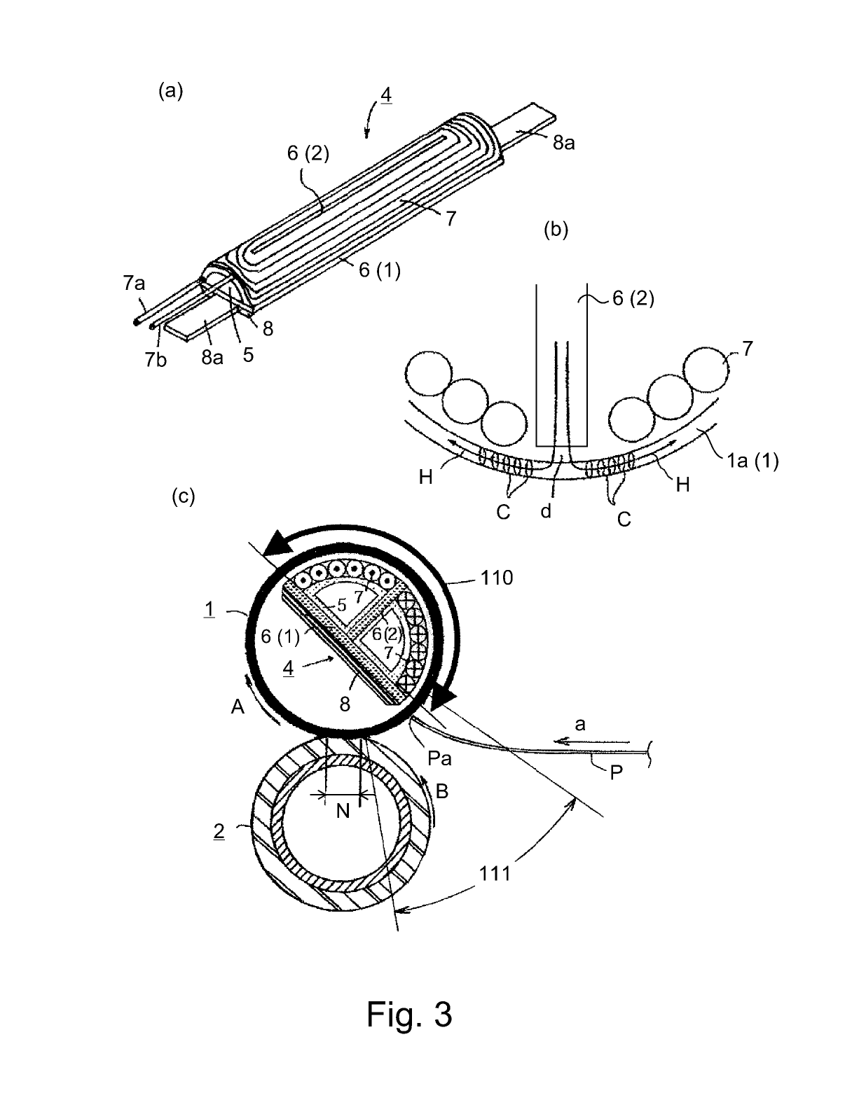

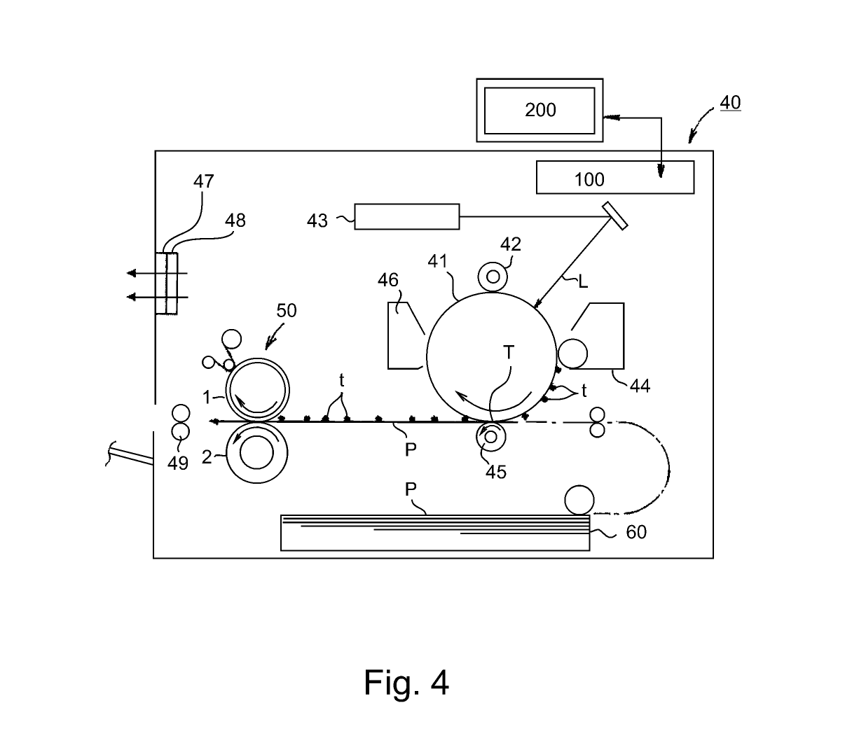

FIG. 4 is a schematic sectional view of an image forming apparatus 40 equipped with a fixing device 50, which is in accordance with the present invention, and which uses one of the electromagnetic induction heating methods. It shows the general structure of the apparatus. This image forming apparatus 40 is a digital image forming apparatus (copying machine, printer, facsimile machine, multifunction machine capable of performing two or more functions of preceding machines, etc.). It uses one of electrophotographic processes, and also, one of the laser-based scanning (exposing) methods.

A referential code 41 stands for a photosensitive member (which is in the form of a drum, and will be referred to as drum, hereafter) as an image bearing member. It is rotationally driven in the clockwise direction indicated by an arrow mark at a preset peripheral velocity. A referential code 42 stands for the primary charging device (charge roller). In this embodiment, the charge roller 42 uniformly and negatively charges the drum 41 to a present level Vd (pre-exposure level). A referential code 43 stands for a laser beam scanner as a drum exposing means, which scans (exposes) the drum 41 with a beam L of laser light which its outputs while modulating the beam L with digital image formation signals inputted into a control circuit 100 from a host apparatus 200 such as an image reading device, a computer, or the like.

As a given point of the peripheral surface of the drum 41 is exposed to the beam L of laser light, this point is reduced in the absolute value of its potential, to potential level V1 (post-exposure level). Consequently, an electrostatic latent image, which reflects the image formation signals, is effected on the peripheral surface of the drum 41 by the contrast between the pre-exposure potential level and post-exposure potential level. This electrostatic latent image is developed by a developing device 44. More specifically, as negatively charged toner particles adhere to the exposed points (which are V1 in potential level) of the peripheral surface of the drum 41, the electrostatic latent image is developed into a visible image, that is, an image formed of toner (which hereafter will be referred to as toner image t).

Meanwhile, one of the sheets P of recording medium such as a sheet of recording paper (which hereafter will be referred to as sheet of paper) is fed into the main assembly of the image forming apparatus 40 from the sheet feeding section 60, and is conveyed, with a preset control timing, to the transfer section T, in which the transfer roller 45, as a transferring member, to which transfer bias is being applied, is being kept pressed upon the drum 41. In the transfer section T, the toner image t formed on the drum 41 is transferred onto the sheet P of paper as if it is peeled away from the peripheral surface of the drum 41. After the transfer of the toner image t onto the sheet P, the sheet P is introduced into the fixing device 50, which will be described later. In the fixing device 50, the toner image t is fixed to the surface of the sheet P by heat and pressure. After being conveyed out of the fixing device 50, the sheet P is conveyed further through the pair of discharge rollers 49, and is discharged, as a finished print, from the image forming apparatus 40.

After the sheet P of paper is separated from the image forming apparatus 40, in the transfer section T, the peripheral surface of the drum 41 is cleaned by the cleaning device 46; the transfer residual toner, that is, the toner which is remaining on the peripheral surface of the drum 41 after the transfer, is removed by the cleaning device 46, so that the peripheral surface of the drum 41 can be repeatedly used for image formation. The heated air discharged into the internal space of the image forming apparatus 40 from the fixing device 50 is exhausted from the image forming apparatus 40 by the fan 48. While the heated air is discharged from the image forming apparatus 40, the odor in the heated air is removed by the filter 47.

The control circuit 100 has a microcomputer (CPU), for example, as its main control circuit. It exchanges various electrical information signals with the host apparatus 200. Further, it controls the processing of the electrical information signals inputted from the various processing devices and sensors of the image forming section (image formation system), the command signals to be sent to the various processing devices, the preset initialization sequence, the preset image formation sequence, etc.

By the way, the image forming apparatus 40 in this embodiment is a black-and-white image forming apparatus. However, the present invention is also applicable to a color image forming apparatus, the image forming section of which has four developing devices which are different in the color of the monochromatic image they form, more specifically, four developing devices which develop an electrostatic latent image into C (cyan), M (magenta), Y (yellow) and K (black) toner images, one for one.

### (2) Fixing Device 50

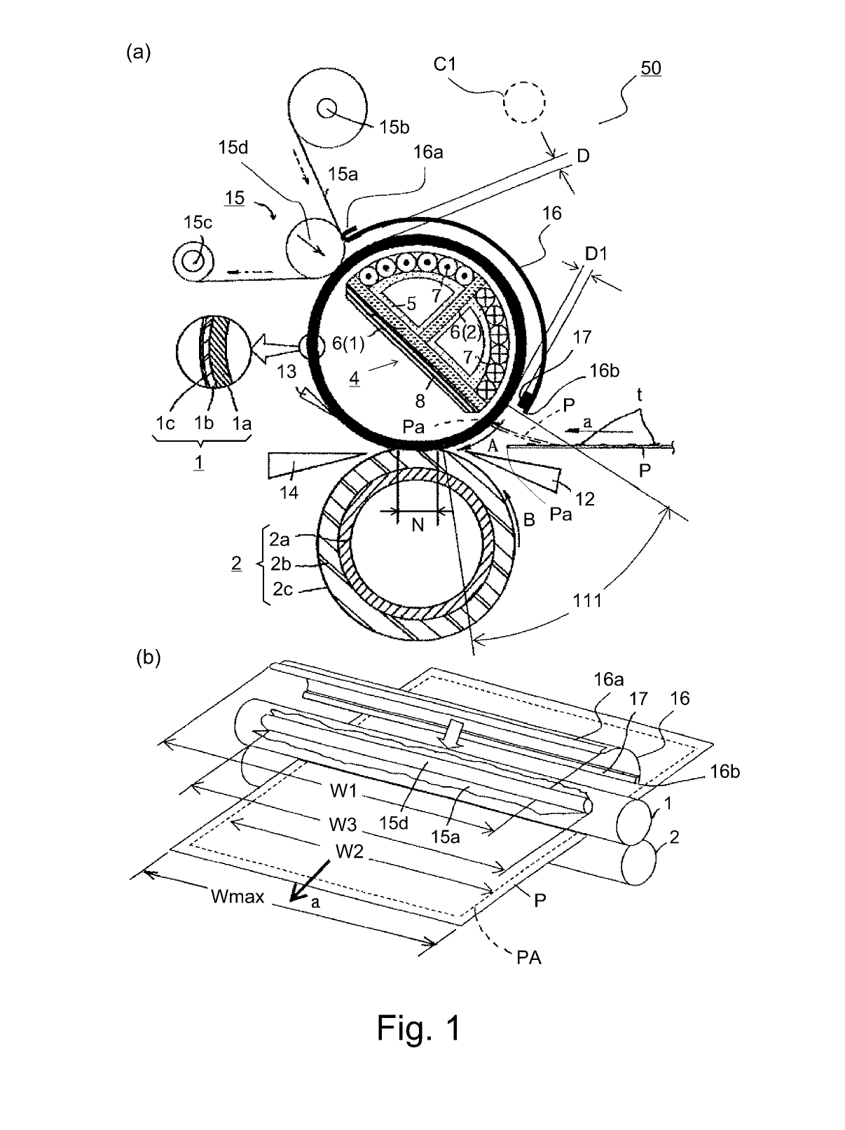

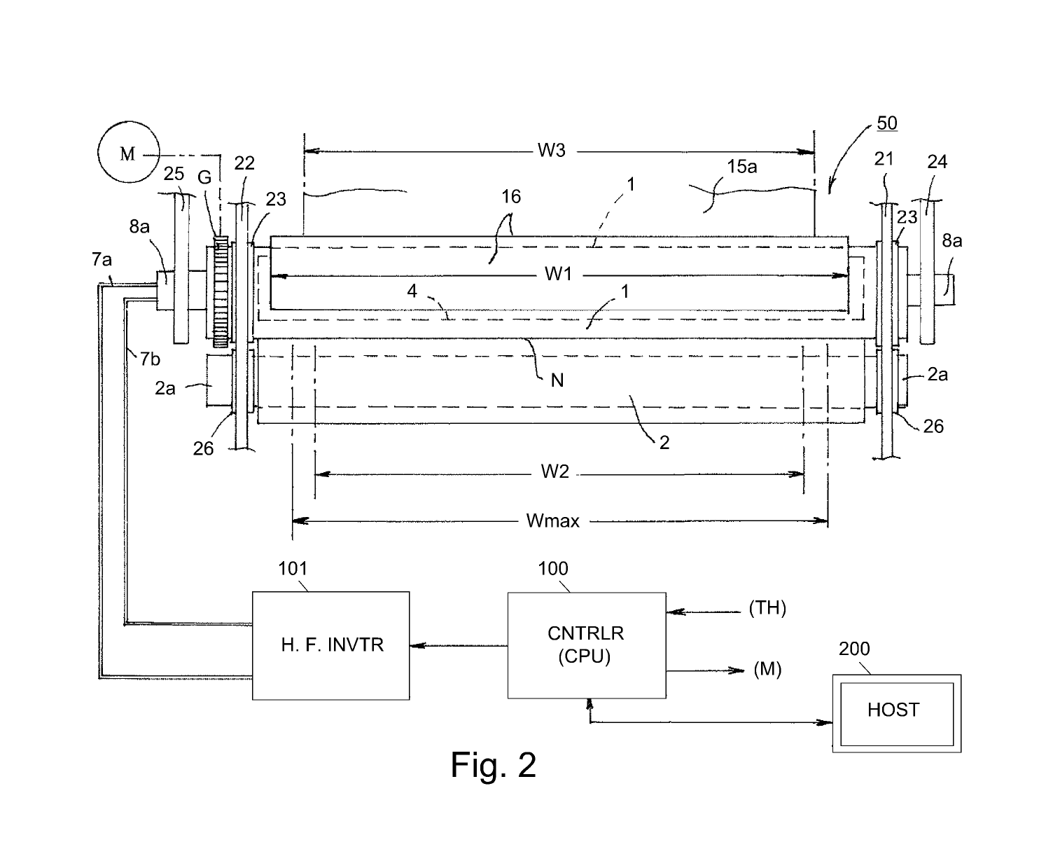

part (a) of FIG. 1 is a schematic cross-sectional view of the essential section of the fixing device 50 in this embodiment, and part (b) of FIG. 1 is a schematic perspective view of the essential section of the fixing device 50. In comparison to part (a) of FIG. 1, part (b) of FIG. 1 is drawn in such a manner that the distance between the fixing device 50 and cover 16 is substantially greater than the actual distance between the two components. FIG. 2 is a schematic front view of the essential section of the fixing device 50.

Regarding the positioning of the fixing device 50, the front side (operator side) is the side from which the sheet P of paper is introduced into the fixing device 50, and the back (rear) side is the opposite side from the front side. The left and right sides of the fixing device 50 are the left and right (rear and front, respectively) sides as seen from the front side. The upstream and downstream sides of the fixing device 50 are the upstream and downstream sides with reference to the sheet conveyance direction a or the rotational direction of the rotational member. The lengthwise and widthwise directions of the fixing device 50 are the directions which are parallel to the rotational axis of the rotational member. The lengthwise and widthwise measurements of the fixing device 50 or any component thereof are the measurements with reference to the above-described lengthwise and widthwise directions. The width of the sheet P of paper, or the widthwise size of the sheet P is the measurement of the paper P in terms of the direction which is perpendicular to the sheet conveyance direction a, at a plane which coincides with the surface of the sheet P.

The fixing device 50 in this embodiment is an image heating device which employs a fixation roller 1 (heat roller) which uses an electromagnetic induction heating system. It has the fixation roller 1 (cylindrical rotational member which can be heated by electromagnetic induction), as the first rotational member (image heating member, which has an electrically conductive layer which can be heated by magnetic flux. The fixing device 50 has also a pressure roller 2, as the second rotational member (opposing member, nip forming member, pressure applying member), which is pressed against the fixation roller 1 to form a nip N (fixation nip) for thermally fixing the toner image t while the sheet P of paper, on which the unfixed toner image t is present, is conveyed through the nip N.

Further, the fixing device 50 has a coil assembly 4 which is disposed in the hollow of the fixation roller 1. The coil assembly 4 has an excitation coil 7 which generates a high frequency magnetic field (alternating magnetic field) which causes the metallic core 1a, which makes up an electrically conductive layer, to generate Joule's heat (heat which can be generated by electromagnetic induction) by inducing electric current (eddy current) in the electrically conductive layer (metallic core 1a). Moreover, the fixing device 50 has a cleaner 15 for cleaning the peripheral surface of the fixation roller 1, and the cover 16 which covers the peripheral surface of the fixation roller 1, in a preset range in terms of the rotational direction of the fixation roller 1, with the presence of a preset gap D between the cover 16 and fixation roller 1. Next, the abovementioned structural components of the fixing device 50 are described in detail.

### (2-1) Fixation Roller 1

The fixation roller 1 in this embodiment is a hollow and laminar roller. It has the cylindrical metallic core 1a which makes up the electrically conductive layer (magnetic shunt alloy layer: metallic layer), a heat resistant elastic layer 1b formed on the peripheral surface of the metallic core 1a, and a surface layer 1c formed on the outward surface of the elastic layer 1b.

The metallic core 1a is a cylindrical hollow roller which is 40 mm in external diameter, 1.2 mm in thickness, and 350 mm in length. In this embodiment, it is formed of magnetic shunt alloy which contains iron, nickel, chrome, manganese, etc., by such ratio that make the alloy 220° in the Curie temperature Tc, and roughly 5 Ω·m in specific resistivity.

In this embodiment, the Curie temperature Tc was set to a level which is no higher than the highest temperature (230° in this embodiment) which the fixing device 50 can withstand. That is, the temperature level at which the temperature of the fixation roller 1 is to be kept was set to a level which is lower than the Curie temperature T of the fixation roller 1. Here, the highest temperature level which the fixing device 50 can withstand means the temperature level beyond which the damage to some of the components of the fixing device 50 will become substantial.

The elastic layer 1b is a heat resistant elastic layer formed of silicone rubber or the like. It is 250 μm in thickness. It is provided to enable the fixing device 50 to fix an unfixed toner image in such a manner that the image forming apparatus 40 is enabled to output high quality images such as color images. The surface layer 1c is formed of fluorine resin such as PFA, PTFE, or the like, and is 20 μm in thickness. It is provided to enable the fixation roller 1 to efficiently release toner.

The fixation roller 1 is rotatably supported by the right (front side) and left (rear side) lateral plates 21 and 22, which are parts of the frame (fixation unit frame) of the fixing device 50, with the placement of a pair of bearings 23, one for one, by which the left and right ends of the fixation roller 1 are borne, respectively.

To the left end of the fixation roller 1, a drive gear G for rotationally driving the fixation roller 1 is coaxially fixed. As driving force is transmitted to the drive gear G from a driving force source M, which is under the control of the control circuit 100, through a driving force transmission system (drive trains), the fixation roller 1 is rotationally driven in the clockwise direction indicated by an arrow mark A in part (a) of FIG. 1, at a preset peripheral velocity.

### (2-2) Coil Assembly 4

There is disposed in the hollow of the fixation roller 1, the coil assembly 4 having the excitation coil 7 which generates high frequency magnetic field (alternating magnetic field) to generate Joule's heat by inducing eddy current in the metallic core 1a.

part (a) of FIG. 3 is an external perspective view of the coil assembly 4. The coil assembly 4 extends in the direction parallel to the rotational axis of the fixation roller 1. It has a bobbin 5, a magnetic core 6 formed of a magnetic substance, and the excitation coil 7. The magnetic core 6 is held by the bobbin 5. The excitation coil 7 is formed by winding a piece of electric wire around the bobbin 5. More specifically, the bobbin 5 also extends in the direction parallel to the rotational axis of the fixation roller 1. Therefore, the lengthwise direction of the excitation coil 7 is parallel to the rotational axis of the fixation roller 1. The magnetic core 6 is disposed in the adjacencies of the excitation coil 7, and guides the magnetic flux to the metallic core 1a, which makes up the electrically conductive layer of the fixation roller 1. The bobbin 5, magnetic core 6, and excitation coil 7 are integrally fixed to the stay 8, being thereby supported by the stay 8.

The coil assembly 4 is stationarily supported by the left and right supporting members 24 and 25 of the fixing device 50, by the lengthwise ends 8a of the stay 8, with the presence of a preset amount of gap d (part (b) of FIG. 3) between the inward surface of the fixation roller 1 and the excitation coil 7. The bobbin 5, magnetic core 6, and excitation coil 7 are disposed in the hollow of the fixation roller 1 in such a manner that they are not exposed from the fixation roller 1.

The magnetic core 6 is made of ferrite, Permalloy, or the like substance, which are high in permeability and low in residual magnetic flux density. It is for guiding the magnetic flux generated by the excitation coil 7, to the metallic core 1a of the fixation roller 1. The magnetic core 6 in this embodiment is shaped like a letter T in cross-section. It is a combination of two pieces 6(1) and 6(b) of magnetic plates, more specifically, a section which is equivalent to the horizontal portion of a letter T, and a vertical section which is equivalent to the vertical section of a letter T.

The excitation coil 7 is a coil which is formed by winding a piece of Litz wire several times around the magnetic core 6(1) in such a manner that the cross-section of the resulting coil matches that of the bobbin 5, which is roughly in the shaped of a long and narrow boat, and also, that the contour of the coil becomes such that the there will be a preset amount of gap between the coil and the inward surface of the fixation roller 1. That is, the excitation coil 7 is wound in such a manner that its lengthwise direction becomes parallel to the rotational axial line of the fixation roller 1. It heats the metallic core 1a of the fixation roller 1 by generating magnetic flux which is perpendicular to the rotational axis of the fixation roller 1. That is, the fixation roller 1 is heated by electromagnetic induction.

Referential codes 7a and 7b stand for a pair of lead wires (which supply excitation coil 7 with electric current) of the above-described excitation coil 7. The wires 7a and 7b are extended from the left side of the stay 8, from within the fixation roller 1, and are in contact with a high frequency inverter 101 (high frequency circuit) which supplies the excitation coil 7 with high frequency electric current. The high frequency inverter 101 has a switching element, which is turned on and off to flow preset high frequency electric current through the excitation coil 7. The high frequency inverter 101 in this embodiment operates at a preset voltage (100 V), and its electric power output is determined by the change in current value, and the length of time the electric current is kept on and off.

### (2-3) Pressure Roller 2

The pressure roller 2 is a heat resistant, multilayered, and elastic roller. It has a metallic core 2a, a heat resistant elastic layer 2b which is coaxially formed, like a roller, around the metallic core 2a, and a surface layer 2c formed on the outward surface of the elastic layer 2b.

In this embodiment, the metallic core 2a is a piece of metallic pipe, which is 38 mm in external diameter, 3 mm in thickness, and 350 mm in length. The elastic layer 2b is in the form of a hollow roller, and covers virtually the entirety of the peripheral surface of the metallic core 2a, except for the left and right end portions of the metallic core 2a, which have a preset length. The surface layer 2c is formed of PFA, PTFE, or the like fluorine resin, and is 100 μm in thickness.

The pressure roller 2 is disposed under the fixation roller 1 roughly in parallel to the fixation roller 1. It is rotatably held by its lengthwise ends, by the right and left lateral plates 21 and 22 of the frame of the fixing device 50, between the two plates 21 and 22, with the placement of a pair of bearings 26 between the lengthwise ends of the pressure roller 2 and two lateral plates 21 and 22, one for one.

The above-described fixation roller 1 and pressure roller 2 are kept pressed upon each other by a preset amount of pressure generated by a pressure application mechanism (pressing means: unshown), against the resiliency of the elastic layers 1b and 2b. Thus, the toner image t on the sheet P of paper is thermally fixed to the sheet P while the sheet P is conveyed between the two rollers 1 and 2 remaining pinched by the two rollers 1 and 2. The fixation roller 1 and pressure roller 2 form the nip N (fixation nip), which is roughly 6 mm in width in terms of the sheet conveyance direction a. As the fixation roller 1 is rotationally driven, the pressure roller 2 is rotated by the rotation of the fixation roller 1, that is, the friction which occurs between two rollers 1 and 2 in the nip N, in the counterclockwise direction indicated by an arrow mark B in part (a) of FIG. 1.

On the upstream side of the nip N in terms of the paper conveyance direction, a pre-fixation guiding plate 12 is disposed, which guides a sheet P of recording paper to the entrance of the nip N as the sheet P is conveyed to the fixing device 50 from the image forming section. On the downstream side of the nip N in terms of the recording paper conveyance direction, a separation claw 13 is disposed in the adjacencies of the fixation roller 1. The separation claw 13 is for preventing the sheet P from wrapping around the fixation roller 1 after the sheet P is introduced into the nip N, and also, for separating the sheet P from the sheet P from the fixation roller 1 as the sheet P comes out of the nip N. Further, on the downstream side of the nip N in terms of the recording paper conveyance direction, a post-fixation guiding plate 14 is disposed, which is for guiding the sheet P to the sheet outlet of the apparatus main assembly as the sheet P comes out of the exit of the nip N.

### (2-4) Cleaner 15

In this embodiment, the peripheral surface of the fixation roller 1 is cleaned by a cleaner 15, which is a cleaning device which uses a cleaning web 15a, which is impregnated a preset amount of silicon oil. The cleaner 15 has: a roll of cleaning web 15a, a web feeding shaft 15b by which the roll of cleaning web 15a is held, a take-up shaft 15c, and a pressing roller 15d which presses the cleaning web 15a upon the peripheral surface of the fixation roller 1, between the two shafts 15b and 15c.

The pressing roller 15d has elasticity. It is for cleaning the peripheral surface of the fixation roller 1. More concretely, it presses the cleaning web 15a on the peripheral surface of the fixation roller 1 to wipe away the toner having transferred onto the peripheral surface of the fixation roller 1. As the cleaning web 15a is sent, little by little, from the feeding shaft 15b to the take-up shaft 15c, the section of the cleaning web 15a, which is in the area of contact between the cleaning web 15a and the peripheral surface of the fixation roller 1, being therefore kept pressed upon the peripheral surface of the fixation roller 1, is replaced by the upstream section of the cleaning web 15a, relative to the area of contact between the web 15a and fixation roller 1, in terms of the direction in which the cleaning web 15a is sent (or taken up). Not only does the silicon oil in the cleaning web 15a prevent the fixation roller 1 from being frictionally worn by the contact between the cleaning web 15a and fixation roller 1, but also, it improves the cleaner 15 (cleaning web 15a) in cleaning efficiency.

A part of the silicon oil adheres to the fixation roller 1, and moves with the peripheral surface of the fixation roller 1, and plays the role of reducing the amount by which the toner transfers from the sheet P of recording paper onto the fixation roller 1. As toner transfers from the sheet P onto the fixation roller 1, it adheres to the silicon oil layer on the fixation roller 1. Therefore, it can be easily scraped away by the cleaning web 15a.

### (2-5) Cover 16

In a case where toner which contains releasing agent (wax) is used, as the toner is heated, the wax (releasing agent) turns into wax dust (microscopic particles which occur as wax vapor condenses), in the adjacencies of the peripheral surface of the fixation roller 1. The cover 16 is for covering the section of the peripheral surface of the fixation roller 1, across which the dust is likely to occur, in order to prevent the dust from dispersing out of the fixing device 50. It is also for boosting the process for increasing the dust in particle size.

More concretely, in this embodiment, the cover 16 is made of a piece of stainless steel plate. It is a component for covering the fixation roller 1 across the portion of the peripheral surface of the fixation roller 1, where the dust occurs, that is, the heating area 110 (part (c) of FIG. 3, with the presence of a preset gap D between the peripheral surface of the fixation roller 1 and the cover 16. In terms of the rotational direction of the fixation roller 1, the cover 16 extends so that the downstream edge 16b of the cover 16 reaches the adjacencies of the area 111 in which as the sheet P of recording paper is introduced into the nip N, it is possible for the leading edge Pa of the sheet P to come into contact with the fixation roller 1. The area 111 is where it is possible that as the sheet P of recording paper enters the nip N, with the leading edge portion of the sheet P curling upward, the leading edge Pa of the sheet P will come into contact with the fixation roller 1, as indicated by a double-dot chain line in part (a) of FIG. 1, and also, as shown in part (c) of FIG. 3.

Referring to part (a) of FIG. 1, the upstream edge (upstream side of rotational member in terms of rotational direction) of the cover 16 in terms of the rotational direction of the fixation roller 1 is in contact with the web 15a, which is a part of the cleaner 15. The upstream edge portion 16a of the cover 16, by which the cover 16 contacts with the web 15a, is outwardly folded back (outwardly folded portion 16a) to ensure that the web 15a smoothly slides on the upstream edge portion 16a (outwardly folded portion) of the cover 16.

The width W1 of the cover 16 is greater than the width W2 of the area PA of the widest (Wmax) sheet of recording paper usable by the image forming apparatus, across which an image can be formed. Further, the width W1 of the cover 16 is greater than the width W3 of the web 15a, which is greater than the width W2. The more detailed description of the cover 16 is given later.

### (2-6) Fixing Operation

As the main power switch (unshown) of the image forming apparatus 40 is turned on, the control circuit 100 starts up the image forming apparatus 40 in the startup mode. As for the fixing device 50, as the driving force source M is started up, the fixation roller 1 begins to be rotated. As the fixation roller 1 begins to be rotated, the pressure roller 2 begins to be rotated by the rotation of the fixation roller 1. Further, the control circuit 100 starts up the high frequency inverter 101 to flow high frequency current to the excitation coil 7.

In this embodiment, the frequency f2 of the high frequency current is 20 kHz. As high frequency current is applied to the excitation coil 7, the metallic core 1a of the fixation roller 1 is heated by the current which is electromagnetically induced in the metallic core 1a by the magnetic flux generated by the application of the high frequency current to the excitation coil 7. Referring to part (c) of FIG. 3, the range 110 in which the fixation roller 1 is heated by electromagnetic induction, is where the distance between the excitation coil 7 and the inward surface of the fixation roller 1 is very small.

In this embodiment, the coil assembly 4 is roughly semi-circular in cross-section. It is stationarily disposed in the hollow of the fixation roller 1 in such an attitude that the semi-circular side of the coil assembly 4 faces up-and-rightward direction, as shown in part (a) of FIGS. 1 and 3(c). In this embodiment, therefore, the heating range 110, across which the fixation roller 1 is heated, in terms of the circumferential direction of the fixation roller 1, is a semi-circular range (180°), which faces up-and-rightward, as shown in part (a) of FIGS. 1 and 3(c).

At this time, referring to part (b) of FIG. 3, the principle based on which the metallic core 1a, which is the electrically conductive layer, of the fixation roller 1 is heated by the electromagnetic induction is described. To the excitation coil 7, alternating current is applied from the high frequency inverter 101. Thus, magnetic flux, which is indicated by an arrow mark H, repeatedly generates and collapses. The magnetic flux H is guided by the magnetic flux passage formed by the combination of the magnetic core 6 and metallic core 1a. As the magnetic flux H is generated by the excitation coil 7 so that it alternately generates and collapses, eddy current is induced in the metallic core 1a in the direction to interfere with the changes in the direction of the magnetic flux. This eddy current is indicated by a referential code C. The amount by which heat is generated by this eddy current C is proportional to the amount (Ω) of the skin resistance Re of the metallic core 1a.

The temperature of the fixation roller 1 is quickly increased to a preset startup completion level, which in this embodiment is 200° or the fixation level, by the above-described electromagnetic induction heating system. The temperature of the fixation roller 1 is detected by a thermistor TH, and the information of the detected temperature is inputted into the control circuit 100. The thermistor TH is disposed in contact with, or close to, the outward, or inward, surface of the fixation roller 1. The control circuit 100 controls the electric power to be supplied to the excitation coil 7 from the high frequency inverter 101, based on the information about the temperature detected by the thermistor TH.

As the control circuit 100 detects through the thermistor TH that the temperature of the fixation roller 1 has reached 200°, it puts the image forming apparatus 40 on standby (in standby mode) in which the image forming apparatus 40 waits for the inputting of image formation signals, and keeps the apparatus 40 on standby. While the image forming apparatus 40 is kept in the standby mode, the control circuit 100 which is a power controlling means, controls the electromagnetic induction heating system in such a manner that the temperature of the fixation roller 1 remains at the fixation level of 200°.

Then, as image formation signals are inputted while the image forming apparatus 40 is kept in the standby mode, the control circuit 100 activates the image forming section (image formation system) to form an unfixed toner image on the sheet P of recording paper. Further, it begins to drive the fixation roller 1 for the second time, with a preset control timing. Then, as the sheet P on which the unfixed toner image t is borne is conveyed through the nip N, remaining pinched by the fixation roller 1 and pressure roller 2, the unfixed toner image t is thermally fixed to the surface of the sheet P. During the heating of the unfixed toner image t (during fixing operation), the control circuit 100 which is an electric power controlling means controls the high frequency electric power in such a manner that the temperature of the fixation roller 1 is kept at the fixation level of 200°.

### (3) Releasing Agent in Toner, and Vaporization of Silicon Oil

Next, the releasing agent in toner, which in this embodiment is wax, is described. It is possible that while an unfixed toner image t is fixed, a phenomenon called “off-set” that the toner on the sheet P of recording paper transfers onto the fixation roller 1 will occur. The “off-set” phenomenon causes such a problem as an image defect.

In the case of the fixing device 50 in this embodiment, therefore, silicon oil is applied to the peripheral surface of the fixation roller 1 with the use of the cleaner 15. However, it is impossible to perfectly prevent the occurrence of the above-described toner offset. In this embodiment, therefore, wax is added to toner. That is, wax is added to toner so that wax oozes out of toner while an unfixed toner image t is fixed. Thus, as the unfixed toner image t is heated, the wax in the toner image t melts and enters, along with silicon oil, into the interface between the peripheral surface of the fixation roller 1 and the toner image t on the sheet P, making it possible to perfectly prevent the occurrence of the offset phenomenon (toner resealing function).

Here, by the way, any chemical compound having a molecular structure like wax will be referred to as wax. For example, a chemical compound having a wax-like molecular structure may be made to react with the resin molecule of the toner. As the releasing agent to be added to toner, other substances than wax may be used. For example, silicon oil or the like which can function as releasing agent may be used. In this embodiment, paraffin wax was used. The melting point Tm of the wax is roughly 75°. That is, the melting point Tm is set so that as long as the temperature of the above-described nip N is kept at the target temperature level, or 200°, the wax in toner instantly melts and oozes into the interface between the toner image t and fixation roller 1.

As the wax oozes out of the toner image on the sheet P of recording paper, it enters the interface between the fixation roller 1 and toner image, and remains there. However, a part of the wax on the fixation roller 1 is heated in the heating range 110 after it transfers onto the fixation roller 1. This phenomenon occurs because the portion of the peripheral surface of the fixation roller 1, which was robbed of heat by the sheet P in the nip N, and therefore, reduced in temperature, is reheated by the excitation coil 7. Thus, the part of the wax, in particular, components which are low in molecular weight, vaporizes (evaporates) as it is moved into the heating range 110 (part (c) of FIG. 3, part (a) of FIG. 7) by the subsequent rotation of the fixation roller 1.

Wax comprises long chain molecular components, which are different in length; it has a specific distribution in terms of the number of long chain molecules. That is, wax contains components which are low in molecular weight and are low in boiling point, and components which are high in molecular weight and are high in boiling point. It is reasonable to think that it is the low molecular weight components, which are parts of the wax that vaporize. By the way, a part of the silicon oil with which the web 15a is impregnated transfers onto the fixation roller 1 as described above, and vaporizes like wax.

As the wax and silicon oil vaporize, they are cooled by the air, and condense into microscopic particles. It is, therefore, possible that immediately after they condense into microscopic particles, they may be in the form of a microscopic particle, the size of which is in a range of several nm-several hundreds of nm. That is, it is possible that there will be dust of wax and silicon oil. However, most of the microscopic particles are in the range of several nm-several tens of nm, in size, which can be confirmed by measuring the dust.

By the way, during the making of the present invention, the dust size was measured with the use of a high speed particle sizer (FMPS: product of TSI, Co., Ltd., USA), which can measure the particle diameter distribution, numerical density (particle count/cm³), weight density (μg/m³). In the case of the present invention, microscopic particles which are no less than 5.6 nm and no more than 560 nm in the particle diameter which can be measured by FMPS, are defined as dust particles.

### (4) Dust Attributable to Fixation

### (4-1) Location of Dust Generation

As the sheet P of recording paper which is bearing a toner image is introduced into the nip N, the wax in the toner image is transferred onto the fixation roller 1. Part (a) of FIGS. 7-7(c) show the processes through which the wax which transferred onto the fixation roller 1 vaporizes. By the way, FIG. 7 does not show the cleaner 15. When the fixing device 50 is in the state shown in part (a) of FIG. 7, only the leading edge portion of the toner image t on the sheet P has moved passed the nip N. Therefore, it is across a range 135a in part (a) of FIG. 7, in terms of the circumferential direction of the 1, that the wax adheres to the fixation roller 1. Thus, the wax does not vaporize, because, in the wax adhesion range 135a, the peripheral surface of the fixation roller 1 is robbed of heat by its contact with the sheet P, and therefore, the surface temperature of the fixation roller 1 has reduced.

When the fixing device 50 is in the state shown in Figure (b), the sheet P has been conveyed further into the nip N. Thus, the wax adhesion range in terms of the circumferential direction of the fixation roller 1 has become a range 135b which is substantially greater than the area 135a. That is, the wax adhesion range 135b partially overlaps with the heating range 110. The portion of the peripheral surface of the fixation roller 1, which is in the overlapping range (range 136 in part (b) of FIG. 7), is higher in temperature. Therefore, the wax begins to vaporize, and also, begins to turn into dust. The wavy lines in Figure excitation coil 7 represent the dust that has generated.

When the fixing device 50 is in the state, shown in part (c) of FIG. 7, the sheet P has been moved further though the nip N, and therefore, the wax adhesion range has expanded to become as large as the range 135c shown in part (c) of FIG. 7. That is, the wax vaporizes and turns into dust, as indicated by the wavy lines, across the much wider range (range 138 in part (c) of FIG. 7, which is roughly equivalent in size to heating range 110 of fixation roller 1).

In this embodiment, in terms of the rotational direction of the fixation roller 1, the cleaner 15 for cleaning the peripheral surface of the fixation roller 1 is on the upstream side of the heating range 110, and on the downstream side of the nip N. That is, the web 15a impregnated with the oil is in contact with the fixation roller 1.

As the silicon oil transfers from the web 15a to the fixation roller 1, it vaporizes and turns into dust, like the wax, primarily in the range 138, shown in part (c) of FIG. 7, that is, the range across which the fixation roller 1 is higher in surface temperature, or the range which is roughly where the heating range 110 of the fixation roller fixation roller 1 is. It is in the range 138, in particular, its section which extends from the area of contact between the web 15a and fixation roller 1, shown in FIG. 1, to the nip N in terms of the clockwise direction of the drawings. This phenomenon occurs because the peripheral surface of the fixation roller 1 is coated with a fresh supply of silicon oil in the abovementioned area of contact.

This dust comprises microscopic particles of wax, and microscopic particles of silicon oil. Therefore, it is adhesive. Thus, it possibly causes problems by solidly adhering to various internal portions of the image forming apparatus 40. For example, if the dust contaminates the recording paper conveyance members such as the pair of discharge rollers 49 by solidly and cumulatively adhering to the recording paper conveyance members, it is possible that the dust (contaminant) will affect image quality by transferring onto the sheet P. Further, it is possible that the dust will clog the filter 47, through which the heated air in the adjacencies of the fixing device 50 is exhausted, by adhering to the filter 47.

### (4-2) Dust Properties

According to the researches done by inventors of the present invention, it has been known that the particle diameter of the dust from the fixation roller 1 is dependent upon the ambient temperature of the fixation roller 1.

Referring to part (a) of FIG. 8, a substance 30, which is high in boiling point (150°-200°) is heated to roughly 200° by being placed on a heat source 30a, the volatile components 31a in the substance 30 vaporizes. As the vapor of the volatile components 31a comes into contact with the air which is normal in temperature, its temperature immediately drops below the boiling point of the volatile components 31a. Thus, it condenses in the air, and turns into microscopic particles 31b (dust), the diameter of which is in a range of several nm-several tens of nm. This phenomenon is analogous to the phenomenon that as the temperature of water vapor falls below the precipitation point, the water vapor turns into microscopic droplets of water, or fog.

Regarding this phenomenon that as gas which is high in temperature comes into contact with such air that is lower in temperature, it condenses into particles, the higher the air in temperature, the less likely is the gas to condense. Thus, the higher the ambient temperature, the smaller the number of dust particles into which the gas turn. Moreover, the portion of the gas, which did not turn into dust particles, and therefore, is remaining floating in the air, collects in the adjacencies of dust particles, and condense onto the dust particles. This phenomenon occurs because, compared to the amount of energy necessary for the residual dust to turn into dust, the amount of energy necessary for the residual dust to condense onto the dust particles is smaller.

It has been known that the dust particles 31b which are born through such a process as the above-described one randomly move in the air (Brownian motion), and therefore, grow into dust particles 31c which are greater in diameter than the dust particle 31b. The greater the dust particle 31b in Brownian motion, in other words, the higher the ambient temperature, the greater this growth of dust particle 31b in diameter. That is, the higher the ambient temperature of the fixation roller 1, the greater in particle diameter, and smaller in numerical count, the dust which is born in the adjacencies of the peripheral surface of the fixation roller 1.

As the dust particles 31b become greater in size (diameter) than a preset value, they gradually slow down, and eventually become stationary. It may be theorized that this phenomenon occurs because as the dust particles 31b grow in size, they become inactive in terms of their Brownian movement.

Regarding the properties of the dust which is traceable to the releasing agent (wax), the dust has been known to adhere to adjacent solid objects. Referring to FIG. 8(b), it is assumed here that an air mass α contains a mixture of the dust particles 31b, which are smaller in size, and the dust particles 31c, which are larger in size, and the air mass α moves toward the wall 33 along with an air current 32. In this situation, the dust particles 31c which are greater in size are more likely to adhere to the wall 33, that is, more likely to be dispersed, than the dust particles 31b which are smaller in size, for the following reason.

That is, it may be reasonable to think that the dust particles 31c are greater in inertia, and therefore, collide with the wall 33 at a greater velocity, than the dust particles 31b. This phenomenon occurs even if the speed of the air current is no more than 0.2 m/sec, which is the slowest speed which can be measured by a wind speed gauge, that is, even if the speed of the air flow is very slow. Therefore, the greater in size the dust particles 31c into which the dust particles 31b grow, in particular, the greater the amount by which the dust 31a is likely to remain in the fixing device 50 (most of it adheres to fixation roller 1 and cover 16). In particular, the dust particles 31c which are roughly several hundreds of nm in size are likely to remain in the fixing device 50; they do not disperse out of the 50.

As described above, the dust 31a has two properties, that is, the property that the higher the ambient temperature, the greater the size of the particles into which it turns, and the property that the greater the dust in particle size, the more likely to adhere to adjacent objects. It is evident, therefore, that the problem that the dust remains the same in particle size as it is immediately after its condensation, and therefore, can disperse (escape) out of the fixing device 50, can be solved by increasing in temperature the air mass α, in which the dust is floating. By the way, how easily the dust increases in particle size is dependent upon the composition, temperature, and density of the dust. For example, as the air mass α increases in temperature, the adhesive components in the dust become softer, increasing therefore in adhesiveness. Moreover, the higher the dust in particle density, the higher the dust in the probability at which the dust particles collide among themselves, and therefore, more likely to agglomerate.

### (5) Dust Dispersion Prevention System

It is evident from the above-described measure for preventing the problem that the dust disperses out of the fixing device 50, based on the above-described properties of the dust, is to increase in temperature, the range 138 across which the dust occurs as indicated by wavy lines in part (c) of FIG. 7.

In this embodiment, therefore, the fixing device 50 is structured so that the above-described area of the fixation roller 1 of the fixing device 50, which corresponds to the range 138 across which the dust occurs, is covered as much as possible. That is, the portion of the peripheral surface of the fixation roller 1, which corresponds to the range 138, across which the dust occurs, is covered with the cover 16 which is formed of a piece of SUS plate, with the presence of a gap D between the peripheral surface of the fixation roller 1 and cover 16.

The cover 16 is disposed so that its downstream edge 16b in terms of the rotational direction of the fixation roller 1 is placed in the upstream adjacencies of the range 111, in which it is possible for the leading edge Pa of the sheet P of recording paper to come into contact with the fixation roller 1 as the sheet P is introduced into the nip N. In this embodiment, the edge 16b of the cover 16 is on the upstream side of the area 111 by 1-3 mm, in terms of the rotational direction of the fixation roller 1. The reason why the range 111 is excluded is to prevent the sheet P from coming into contact with the cover 16, in order to ensure that the sheet P is smoothly conveyed.

The upstream edge of the cover 16 in terms of the rotational direction of the fixation roller 1 is in contact with the web 15a, which is a part of the cleaner 15. The portion 16a of the cover 16, which contacts the web 15a is outwardly folded back, in order to enable the web 15a to smoothly slide against the cover 16.

Further, the width W1 of the cover 16 is set to be wider than the width W2 of the portion of the widest sheet P (having widest width Wmax) of recording paper usable by the image forming apparatus image forming apparatus 40. That is, the fixing device 50 is structured so that the cover 16 extends beyond both edges of the portion PA of the sheet P, across which an image can be formed, in terms of the widthwise direction. Further, the width W1 of the cover 16 is set to be wider than the width W3 of the web 15a. Since the width W1 of the cover 16 is set to be wider than the width W3 of the web 15a, it is ensured that the peripheral surface of the fixation roller 1 is virtually entirely covered with the cover 16, across the dust generation range.

Because the fixing device 50 is structured as described above, the cover 16 is enabled to cover the peripheral surface of the fixation roller 1, across virtually the entirety of the range 138 across which the wax and silicon oil turn into the dust. Thus, the heat from the fixation roller 1 can be utilized to increase in temperature, the air mass in the immediate adjacencies of the peripheral surface of the fixation roller 1, in order to increase the dust in particle diameter to prevent the dust from dispersing out of the fixing device 50. As the dust increases in particle diameter, it adheres to the cover 16 or fixation roller 1. As the dust adheres to the fixation roller 1, it transfers onto the sheet P. However, it does not affect image quality, because even the largest dust particles are microscopic.

Further, the cover 16 has a rib 17 which protrudes from the inward side of the cover 16 toward the fixation roller 1, and extends across the entirety of the cover 16 in terms of the lengthwise direction of the cover 16. That is, the lengthwise direction of the rib 17 coincides with the widthwise direction of the cover 16 (rib 17 extends from one lengthwise end of fixation roller 1 to the other). The rib 17 interferes with the airflow into, or out of, the space between the cover 16 and fixation roller 1, to play the role of promoting the temperature increase of the air in the space.

### (6) Positioning of Cover 16 (Gap D Between Cover 16 and Fixation Roller 1)

### (6-1) Airflow in Immediate Adjacencies of Fixation Roller 1

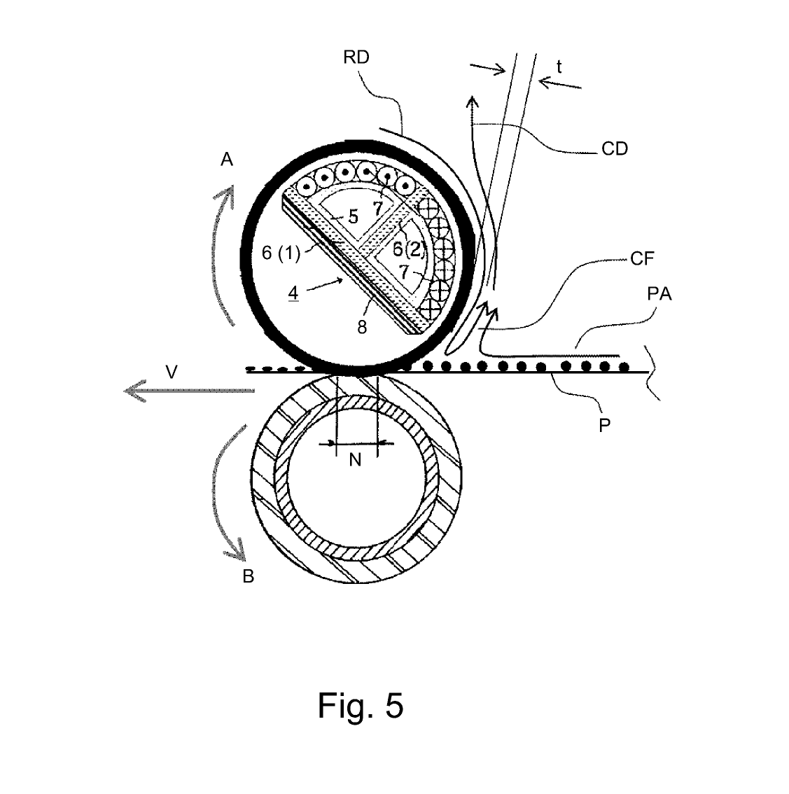

Before stating about the positioning of the cover 16, the airflow in the immediate adjacencies of the peripheral surface of the fixation roller 1 is described based on the results of the simulation of the flow of the heated air shown in FIG. 5. In this simulation regarding the relationship between the heat and airflow, it is assumed that the surface temperature of the fixation roller 1 is 200°; the fixation roller 1 is rotating in the clockwise direction indicated by an arrow mark A at a peripheral velocity of V; the pressure roller 2 is rotating in the counterclockwise direction indicated by an arrow mark B at the same peripheral velocity V as the fixation roller 1; and the sheet P of recording paper is being moved in the leftward direction in FIG. 5 at the same speed V as the peripheral velocity of the two rollers 1 and 2. In this simulation, therefore, the following factors are taken into consideration:

Upward airflow (CD) attributable to natural convection which occurs in the immediate adjacencies of the peripheral surface of the fixation roller 1,

Airflow caused by the movement of the peripheral surface of the fixation roller 1 along the peripheral surface of the fixation roller 1 (RD),

Air flow caused along the sheet P by the movement of the sheet P (PA).

Referring to FIG. 5, at the entrance of the nip N, the airflow (PA) and airflow (RD) collide with each other, and lose their directionality. Consequently, they join and form an airflow (CF), which seems as if it is coming out of the nip N. This was confirmed. The airflow (CF) flows in the opposite direction from the airflow (RD) while remaining next to the airflow (RD). That is, it flows upward along the peripheral surface of the fixation roller 1, and is drawn into the upward airflow (CD).

### (6-2) Function of Cover 16 and Gap D

As described above, the cover 16 has the function of increasing in temperature, the air mass which is in the immediate adjacencies of the portion of the peripheral surface of the fixation roller 1, which corresponds to the dust generation range 138. Front the standpoint of ensuring that the cover 16 performs its function, it has to be prevented that the airflow (CF) attributable to the airflow (PA) which occurs in the adjacencies of the surface of the sheet P, and which is lower in temperature, and the upward airflow (CD), enter the gap D between the cover 16 and fixation roller 1. Thus, the cover 16 is disposed as close as possible to the peripheral surface of the fixation roller 1 as shown in Figure fixation roller 1. Therefore, the bottom edge 16b of the cover 16 can deflect the airflow (CF) and upward airflow (CD) in the direction to move away from the fixation roller 1.

Further, by disposing the cover 16 so that the gap D between the cover 16 and fixation roller 1 becomes no less than 0.5 mm and no more than 3.5 mm, it is possible to ensure that the cover 16 satisfactorily performs its function of deflecting the airflow (CF) and upward airflow (CD) away from the fixation roller 1. By setting the gap D to be no more than 3.5 mm, it is possible to reduce the dust density of the point C1 (part (a) of FIG. 1), which is in the adjacencies of the fixing device 50, to no more than 70%, as will be described later.

By the way, the reason why the smallest value for the gap D was set to 0.5 mm is that if the dispersion prevention system is positioned closer to the peripheral surface of the fixation roller 1 than 0.5 mm, it is possible that the cover 16 will come into contact with the fixation roller 1. In this embodiment, the gap D between the cover 16 and fixation roller 1 is 2 mm. Further, the cover 16 is provided with the rib 17 which is positioned along the bottom edge 16b of the cover 16 to enhance the cover 16 in its function to deflect the airflow (CF) and upward airflow (CD) away from the fixation roller 1.

The gap D between the cover 16 and fixation roller 1 is desired to be as narrow as possible across the entire range of the cover 16. The narrower the gap D, the better the cover 16 can prevent the airflow (CF) and upward airflow (CD) from entering the gap D. Moreover, the narrower the gap D, the quicker the space between the fixation roller 1 and cover 16 can be increased in temperature. However, in consideration of the thermal deformation of the cover 16, and also, the accuracy with which the cover 16 can be positioned, it is difficult in some cases to position the cover 16 so that the gap D becomes as narrow as possible across the entire range of the cover 16.

In this embodiment, therefore, the cover 16 is provided with the rib 17, which is positioned so that the gap D1 between the cover 16 (rib 17) and fixation roller 1 becomes 1 mm. Providing the cover 16 with the rib 17, which will be closer to the fixation roller 1 than the main section of the cover 16, can enhance the cover 16 in its function of deflecting the airflow (CF) and upward airflow (CD) away form the fixation roller 1. Further, the rib 17, which is for reducing the gap between the cover 16 and fixation roller 1 can be formed as an integral part of the cover 16. That is, it is simple in design, and is easy to manufacture.

By the way, the rib 17 may be positioned higher than the adjacencies of the bottom edge 16b of the cover 16. For example, the rib 17 may be positioned roughly the same level as the rotational axis of the fixation roller 1, because, even if the rib 17 is positioned at a higher level than the bottom edge 16b of the cover 16, it interferes with the flow of the airflow (CF) and upward airflow (CD) after they enter the gap D between the cover 16 and fixation roller 1.

Further, in this embodiment, the up-and-outwardly folded portion 16a of the cover 16 is placed in contact with the web 15a. Since the web 15a blocks the gap between the cover 16 and fixation roller 1, and therefore, prevents the air movement in the gap. Thus, the web 15a plays the role of assisting the air in the gap in increasing in temperature. By the way, in consideration of the frictional wear or the like of the web 15a, it is difficult in some situations, to keep the cover 16 and web 15a in contact with each other. In such situations, the gap between the cover 16 and web 15a is to be made as narrow as possible, from the standpoint of design. For example, it is to be set to be in a range of 1-2 mm.

### (6-3) Effects of Cover 16

By positioning the cover 16 as described above, it was possible to keep the dust density, which is measured at the point C1 shown in part (a) of FIG. 1, no more than 70%, which is substantially lower than that in a case where the cover 16 is not present. There is expected a measurement error of 30%. Thus, the target value below which the cover 16 is deemed effective was set to 70%. The point C1 is in the passage through which the dust having generated from the toner is discharged from the space (gap) between the peripheral surface of the fixation roller 1 and the cover 16, by the upward airflow attributable to thermal convection. It is positioned roughly 20 mm away from the fixation roller 1. If the fixing device 50 is reduced to no more than 70% in terms of the dust density measured at the point C1, it is possible to significantly reduce the contamination of the interior of the image forming apparatus image forming apparatus 40, which is attributable to the wax which escapes from the fixing device 50.

This dust density can be measured with the use of the abovementioned high speed particle sizer (FMPS). The dust density was measured under the following condition. More concretely, the original was 5% in print ratio, and the fixing operation was continuously carried out for eleven minutes while feeding sheets P of recording paper, which was A4 in size, in the landscape attitude. During the operation, the dust density was measured for one minute before the fixing operation was ended (during 11th minute). The dust density in this embodiment is the average of the dust densities measured throughout the 11th minute.

By the way, the point at which the dust density is to be measured may be any point in the area, in FIG. 4, in which the pair of discharge rollers 49, filter coil assembly 4, etc., are possibly soiled by the wax, because the effectiveness of the cover 16 in this embodiment in preventing the contamination attributable to the wax in toner can be estimated by measuring how much the dust density was reduced by the cover 16, even though the dust density varies depending on where it is measured.

Further, in this embodiment, the dust density means the particle count density (particle count/cm³) of the dust, that is, the number of dust particles, per cubic centimeter, which are no less than 5.6 nm and no more than 560 nm in size. Thus, it is desired that the cover 16 is designed and positioned so that providing the fixing device 50 with the cover 16 reduces the dust density to no more than 70% of that of the fixing device 50 which does not have the cover 16. By the way, instead of the particle count density (particle count/cm³), the weigh density (μg/m³) may be used as the dust density.

Next, in this embodiment, the gap D between the cover 16 which does not have the rib 17, and the peripheral surface of the fixation roller 1 was reduced in steps to 4.0 mm, 3.5 mm, 2.5 mm, 2.0 mm and 1.5 mm. As a result, it was verified that the narrower the gap D, the lower the dust density measured at the point C1. That is, it was confirmed that when the gap D is no more than 3.5 mm, the above-described condition (dust density measured at point C1 is no more than 70%) is satisfied.

In this embodiment, the cover 16 was positioned so that the gap D is 2 mm. Moreover, the cover 16 was provided with the rib 17, and the cover 16 was positioned so that the gap D1 between the rib 17 and fixation roller 1 is 1 mm. The fixation roller 1 is a rotational component as described above. Therefore, the gap D and gap D1 change in value as the fixation roller 1 rotates. Further, sometimes, contaminants such as paper dust accumulate on the cover 16, and therefore, the gap D and gap D1 narrow.

In order to ensure that the cover 16 and fixation roller 1 do not come into contact with each other, the gap D and gap D1 were set to 1.0 in order to provide a sufficient amount of margin for errors in design. The dust density measured at the point C1 in the fixing device 50 designed as described above was no more than 40% of that in a fixing device which did not have the cover 16.

### (6-4) Other Methods for Properly Setting Gap D

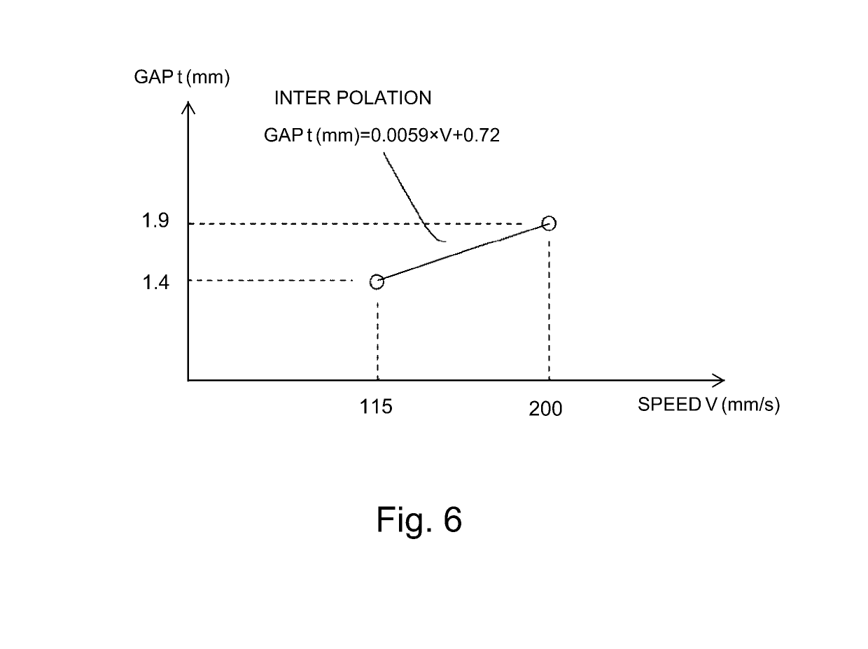

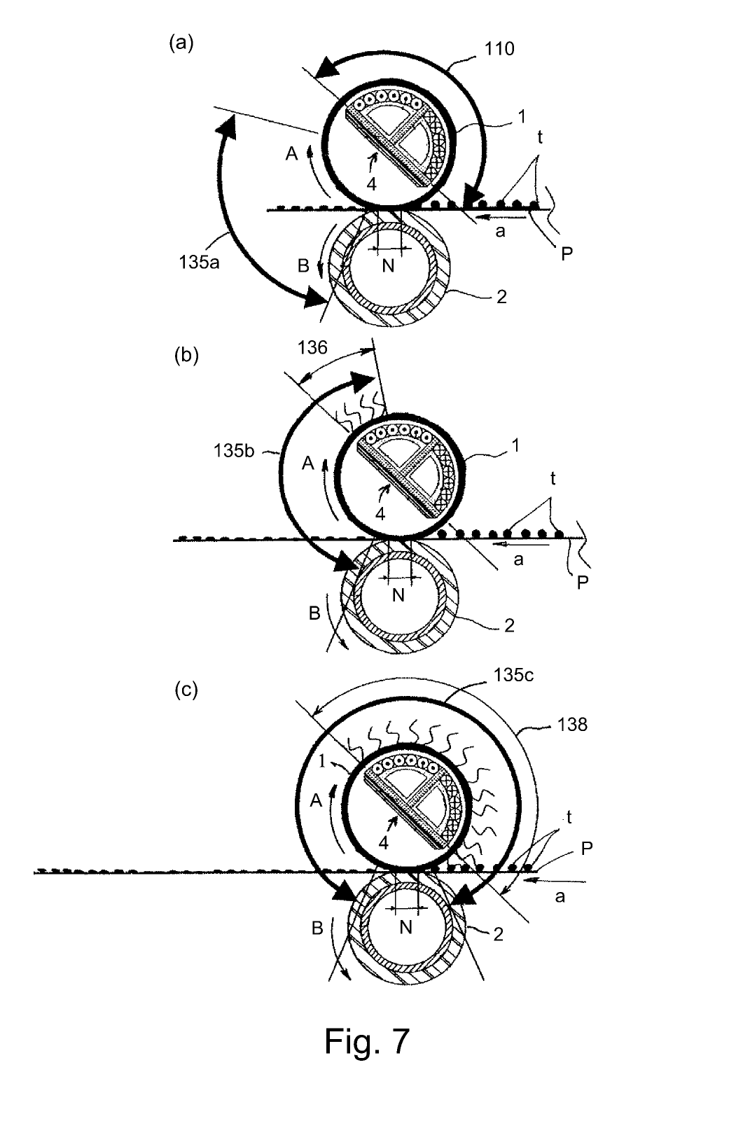

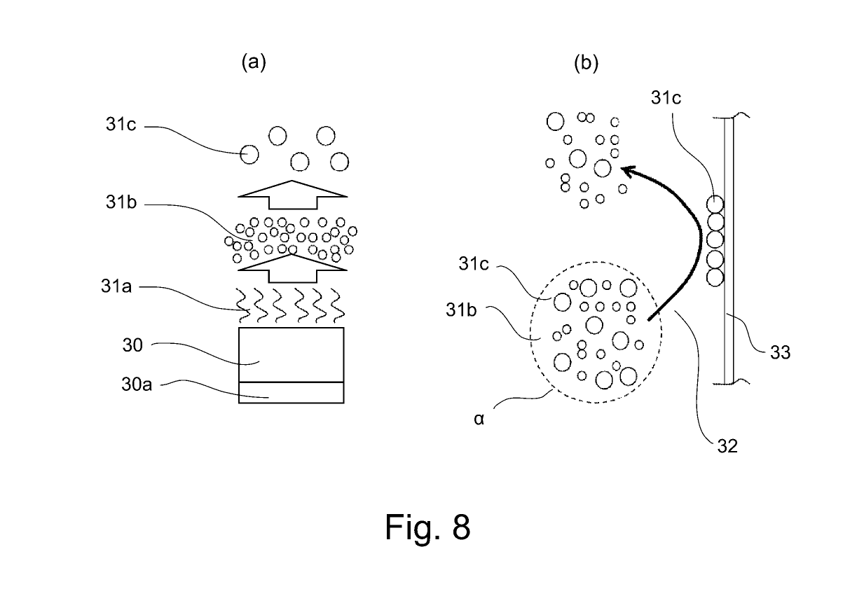

The gap D may be set according to the peripheral velocity of the fixation roller 1. A referential letter t in FIG. 6 stands for the width of the airflow in FIG. 5. That is, “t” stands for the distance from the border between the airflow (RD) and air flow (CD), to the fixation roller 1. The effects of this “t” were verified by simulation. FIG. 6 shows the results of the simulation.

Referring to FIG. 6, when the peripheral velocity V of the fixation roller 1 was 115 mm/s, t=1.4 mm, whereas when the peripheral velocity V of the fixation roller 1 was 200 mm/s, t=1.9 mm. As for the volume of the airflow (RD) along the peripheral surface of the fixation roller 1, the greater the speed of the peripheral surface of the fixation roller 1 (that is, peripheral velocity V), the greater the volume of the airflow (RD). Therefore, it was reasonable to think that as the fixation roller 1 increased in peripheral velocity V, the airflow (RD) increased in volume, and therefore, “t” increased in value. The following equation can be obtained by linear interpolation of the two points in FIG. 6.

t=0.0059×V+0.72

As long as the gap D is set to be no more than the value of the above-described t, it is ensured that the cover 16 can block the airflow (CF) and airflow (CD) to prevent the ambient temperature of the fixation roller 1 from undesirably reducing, in order to minimize the amount of dust generation. In a case where it is difficult to set the gap D to be no more than the above-described t, it is acceptable to set the gap D1 to be no more than the above-described t.

By the way, the smallest value for “t” is 0.5 mm as described above. Thus, the range of the gap D can be expressed by the following mathematical expression, that is, a combination of the equation given above, and this smallest value for “t”.

0.5≦D≦0.0059×0.72

In a case where it is difficult to keep the value of the gap D within the above-described range, the gap D1 may be set to be within a range which is defined by the following mathematical expression

0.5≦D1≦0.0059×0.72.

The mathematic expressions given above are effective only when the peripheral velocity V of the fixation roller 1 is within a range which satisfies: 115 mm/s≦V≦200 mm/s. However, the relationship between the peripheral value V and “t” may be thought to be linear. Therefore, the two expressions are effective even in a case where the velocity V is not within the above defined range.

In the foregoing, the structure and effects of the cover 16, in this embodiment, which is for the fixation roller 1, were described. In consideration of thermal deformation and corrosion of the 16, SUS was selected as the material for the cover 16. However, the material for the cover 16 may be different from SUS. For example, it may be a resinous substance. As long as the material for the cover 16 is thermally insulative, the cover 16 is effective to increase the temperature of the immediate adjacencies of the peripheral surface of the fixation roller 1. The rib 17 with which the cover 16 is provided may be an integral part of the cover 16, or an independent part from the cover 16. In this embodiment, the cleaner 15 has the web 15a. However, the cleaner 15 does not need to have the web 15a. That is, it may have a cleaning member other than the web 15a. For example, it may be a cleaning roller.

### [Miscellanies]

1) A fixing device includes an image quality improving device (which also is called fixing device) for applying heat and pressure, for the second time, to a toner image which has been temporarily or permanently fixed to a sheet of recording paper, in order to improve the toner image in quality, in addition to a device for fixing an unfixed toner image.

2) The cylindrical rotational member, as an image heating member, which can be heated by electromagnetic induction, may be a flexible endless belt which is loosely fitted around its supporting member, which functions also as a guiding member, and is rotationally driven, or a flexible endless belt which is supported and kept tensioned by multiple members, and which is rotationally driven.

3) In a case where the cylindrical rotational member 1, as an image heating member, which can be heated by electromagnetic induction, is rotationally driven, the member 2 which opposes the rotational member fixation roller 1 and forms the nip N in coordination with the rotational member 1 may be a non-rotational member, such as a rectangular pad, the surface of which is less in coefficient of friction than the rotational member 1 and a sheet P of recording paper. In the case where the member 2 is a non-rotational member, as the sheet P of recording paper is introduced into the nip N, it is conveyed through the nip N by the friction between the sheet P and rotational member 1 while sliding on the surface of the non-rotational member 2, which is smaller in coefficient of friction than the rotational member 1 by its back surface (on which image is not formed), remaining sandwiched between the rotational member 1 and non-rotational member 2.

4) The image forming section (image forming system) of the image forming apparatus, which forms a toner image on a sheet P of recording paper is not limited to an electrophotographic image forming section of the transfer type in this embodiment. For example, it may be an electrophotographic image forming section which uses a sheet of photosensitive paper as recording medium, and directly form a toner image on the sheet of photosensitive paper. Further, it may be an image forming section of the transfer type, which uses a dielectric member on which an image is electrostatically recordable, as an image bearing member, or a magnetic member, as an image bearing member, on which an image can be magnetically recordable. Further, it may be an electrostatic image forming section which uses a sheet of electrostatic recording paper or magnetic recording paper, as recording medium, and directly form a toner image on the recording medium. Moreover, it may be a color image forming section.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

### INDUSTRIAL APPLICABILITY

According to the present invention, a fixing device which can prevent the dust from dispersing straight out of the fixing device is provided.

1. A fixing apparatus comprising:
a first rotatable member configured to heat, in a fixing nip, an unfixed toner image formed on a sheet with toner comprising the parting material;
a second rotatable member cooperative with said first rotatable member to form the fixing nip;
a cleaner configured to clean said first rotatable member; and
a covering member configured to cover said first rotatable member over a range from said cleaner to a neighborhood of an entrance of said fixing nip along a rotational direction of said first rotatable member with a gap of not less than 0.5 mm and not more than 3.5 mm.

2. An apparatus according to claim 1, wherein said covering member is provided with a projection extending toward said first rotatable member at one end portion of said covering member with respect to the rotational direction, and the projection extends along a longitudinal direction of said first rotatable member.

3. An apparatus according to claim 2, wherein said covering member is provided with a sliding portion slidable relative to said cleaner at the other end portion with respect to the rotational direction.

4. An apparatus according to claim 3, wherein said cleaner includes a web, and said sliding portion is slidable relative to said web.

5. An apparatus according to claim 1, wherein the gap D between said covering member and said first rotatable member (mm) and the peripheral speed of said first rotatable member (mm/s) satisfy,
0.5≦D≦0.0059×0.72.

6. An apparatus according to claim 1, wherein said covering member has a width larger than a maximum width in which the image can be formed on a maximum width sheet usable with said apparatus.

7. An apparatus according to claim 1, further comprising a heating member configured to heat said first rotatable member.

8. An apparatus according to claim 1, wherein the parting material comprises a wax.
